(19) United States
(12) Patent Application Publication
(10) Pub. No.: US 2024/0177198 A1
(43) Pub. Date: May 30, 2024

(54) SYSTEM AND METHOD FOR IMPLEMENTING A VIRTUAL AGENT FOR PERSONALIZED COMMUNICATION

(71) Applicant: B2B Rocket LLC, Sheridan, WY (US)

(72) Inventor: Shivanshu GUPTA, Sheridan, WY (US)

(21) Appl. No.: 18/434,472

(22) Filed: Feb. 6, 2024

(51) Int. Cl. G06Q 30/0251; G06Q 10/1093; G06Q 30/0201

(52) U.S. Cl. CPC G06Q 30/0271; G06Q 10/1095; G06Q 30/0201; G06Q 30/0267

(57) ABSTRACT

A method and system for implementing a virtual agent for personalized communication is disclosed. The method includes identifying a plurality of prospective customers for a business, sending via a text-based messaging application operatively coupled to the virtual agent a personalized message related to the business to a prospective customer, and determining in real-time a sequence of messages to send to the prospective customer based on a response of the prospective customer to one or more previous messages. Incase the response from the prospective customer indicates a positive interest of the prospective customer in the business, a meeting is for the prospective customer. The prospective customer is engaged by the virtual agent via an interactive communication platform into an interactive personalized communication during the meeting for converting the prospective customer into customer of the business.

### FIELD

The present disclosure related to online sales and recommendation systems and more particularly, to a system and method for implementing a virtual agent for personalized communication for promoting sales of a business.

### BACKGROUND

During a physical or face-to-face interaction between two people, a first person may try to understand the other person's interests, preferences, views, personality, mood and likes before recommending something to that person. However, in an electronic environment, gaining an understanding of a user in order to generate recommendations of services and/or products that matches the interests of the user and that results in a positive engagement with the user is a difficult challenge.

Further, in business to business (B2B) sales and marketing for any industry, it is desirable to have a personal touch while communicating with prospective customers. A balance between aggressive sales and personalized communication is the key to successful lead generation and closure in any business transaction. Generally, a good sales person having relevant years of experience is hired for successful marketing and lead generation for a business undertaking. A sales person usually identifies relevant customers based on a market search of the industry and customer base. Further, a good sales person engages a target customer into an interactive and rich conversation to ensure closing the deal with such customer. However, hiring good sales persons may not always be compatible economically for a business. Generally, sales force of a business could cost up to 30% of the revenue as it includes extensive training, manual processes and high salaries. Further, the reach of the sales force is limited to human inefficiencies and lack of perseverance.

There is a need for an intelligent proactive virtual agent for a business enterprise that can model the market composition and target customers for the enterprise, and use the model to engage with the customers in an interactive manner that helps in convincing the customers to enroll or purchase the services or products of the business enterprise. Generally, text messages like emails serve as a powerful tool to generate leads (also known as prospective customers) and convert potential leads into long time customers. The proactive virtual agents must be engineered to automatically connect with ideal customers through interactive email communications personalized to a customer, and build stronger connections with the customer.

Hence, a system and a method that implements a virtual agent for having personalized and interactive sales communication for engagement with the customer is proposed.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for having personalized communication with users for promoting sales of a business is proposed. The system includes a memory comprising instructions, and a processing device operatively coupled to the memory, to execute instructions to facilitate a virtual agent, to identify a plurality of prospective customers for a business, send via text-based messaging application operatively coupled to the virtual agent, a personalized message related to the business to a prospective customer, determine in real-time a sequence of messages to send to the prospective customer based on a response of the prospective customer to one or more previous messages; arrange a meeting for the prospective customer when the response from the prospective customer indicates a positive interest of the prospective customer in the business; and engage via an interactive communication platform into an interactive personalized communication during the meeting for converting the prospective customer into customer of the business.

According to another example embodiment, a method for facilitating personalized communication with a plurality of users for promoting sales of a business is disclosed. The method includes, identifying, by a virtual agent implemented by a processing device, a plurality of prospective customers for a business, sending, via one of a text-based messaging application and an interactive communication platform, a personalized message related to the business to a prospective customer, wherein the text-messaging application and the interactive communication platform is operatively coupled to the virtual agent; determining, by the virtual agent, in real-time a sequence of messages to send to the prospective customer based on a response of the prospective customer to one or more previous messages; arranging, by the virtual agent, a meeting for the prospective customer when the response from the prospective customer indicates a positive interest of the customer in the business; and engaging, by the virtual agent, via the interactive communication platform into an interactive personalized conversation during the meeting for converting the prospective customer into a permanent customer of the business.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a schematic block diagram of a system for implementing a virtual agent for personalized communication, according to an embodiment of the present invention;

FIG. 2 is a schematic block diagram of a content database of the system of FIG. 1, according to an embodiment of the present invention;

FIG. 3 is a flowchart of a method for implementing a virtual agent for personalized communication, according to some aspects of the present invention; and

FIG. 4 is a block diagram of an embodiment of a computing device in which the modules of a system for implementing a virtual agent, described herein, are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/actions/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide a method and system for implementing a virtual agent for personalized communication. The system is typically located on a cloud network and is scalable, performant and efficient in terms of digital communication and resource utilization compared to existing systems that implement personalized communications.

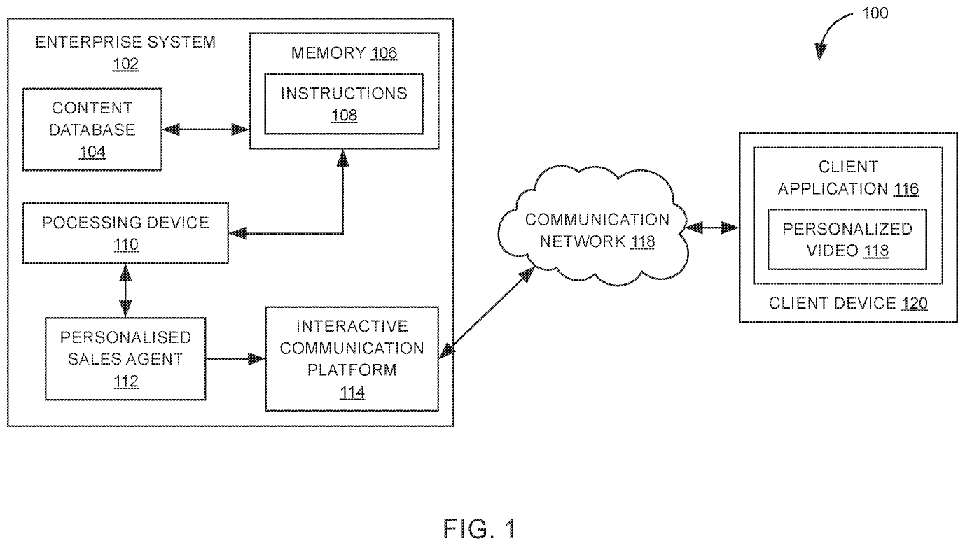

FIG. 1 illustrates a block diagram of a system (100) for implementing a personalized virtual agent. The system (100) includes an enterprise system (102) in communication with a plurality of client devices (120a-120n) over a communication network (118). The enterprise system (102) comprises a content database (104), a processing device (110), a virtual agent (112), a memory (106) comprising instructions (108), a text-based messaging application (114), and an interactive communication platform (116). The processing device (110), the memory (106), the virtual agent (112) are communicatively coupled via one or more communication links. The communication links can be dedicated wired links or wireless links.

The processing device (110) is operatively coupled to the memory (106) to execute the instructions (108) to facilitate the virtual agent (112) to perform a plurality of operations. The virtual agent (112) communicates with the plurality of client devices (120a-120n) via the text-based messaging application (114) or via the interactive communication platform (116). The text-based messaging application (114) can be a short messaging service (SMS) application, an instant messaging (IM) application, or an email application or a combination thereof. The interactive communication platform (116) can be a chat application, or an interactive voice system through which the virtual agent (112) interacts with the plurality of client devices (120a-120n). Typically, a client device (e.g. 120a) can be a user device like a mobile phone, laptop, personal digital assistant and the like which has a client application (122a) like an email client or a chat client through which a prospective customer or a user interacts with the virtual agent (112).

In an embodiment, the virtual agent (112) is configured to perform a plurality of operations for interacting with one or more prospective customers for selling or facilitating marketing of products and services of an enterprise or a business to which the enterprise system (102) belongs to. For example, in case the enterprise sells computer accessories the virtual agent (112) can be an email agent that is configured to send personalized emails, schedule meetings, and engage interactively with the one or more prospective customers to recommend and sell one or more computer accessories that cater to the needs and likes of each prospective customer. In order to achieve the aforesaid, the virtual agent (112) is configured to identify a plurality of prospective customers for the business. For example, the virtual agent (112) would identify females interested in sports when the business pertains to sale of female sportswear, and health memberships.

Further, the virtual agent (112) is configured to send via the text-based messaging application (114) a personalized message to a prospective customer. The processing device (110) can be configured to instruct the virtual agent (112) to set a tone of the personalized message. In an embodiment, the tone can be set to a friendly tone for a predefined set of products and services, for example kids toys and amusements. In another embodiment, the tone of the personalized message can be set to a professional tone. For example, the professional tone can be apt for services such as sale of software applications.

The personalized message can be accessed via a client application (122a) hosted on a client device (120a). Examples of the client application (122a) can include an email client, a SMS application, an instant messaging application and the like. The personalized message can be related to the business, likes or preferences of the prospective customer. Typically, the virtual agent (112) is trained to understand a need, requirement or preference of the prospective customer via a plurality of information channels such as social media, professional links, websites, community websites, newspaper articles and the like. The personalized message can be an email, introducing the prospective customer to the business of the enterprise. Further, the email is personalized for the prospective customer in order to increase an interest and engagement level of the prospective customer. It may be noted, that the virtual agent (112) can be trained to filter our spam emails from reaching the prospective customer.

Further, the virtual agent (112) can be configured to determine in real-time a sequence of messages to be sent to the prospective customer. The sequence of messages can be based on a response of the prospective customer to one or more previous messages. For example, the virtual agent (112) can send a first message (e.g. a first email) to the prospective customer based on a profile and preferences of the prospective customer. The profile and preferences of the prospective customer can be gathered from a plurality of information sources. The preferences and profile of the prospective customer are stored in the content database (104). Further, the virtual agent can send a reminder message to the prospective customer when the prospective customer fails to open the message or reply to the message within a first predefined time period. For example, in case the prospective customer fails to reply to the first email within three (3) days of receiving the first email, the virtual agent (112) can send a reminder email on the third day. Incase the prospective customer fails to reply even to the reminder email within a predefined time period, say three more days, the virtual agent (112) can send a second reminder email and so and so forth.

When no response is received from the prospective customer despite multiple reminder emails, the virtual agent (112) can remove the prospective customer from a list of prospective customers stored in the content database (104). Typically, the virtual agent (112) may wait for the response for a second predefined time period (for example 15 days) after sending a last reminder email, before removing the prospective customer from the list.

Further, upon receiving a reply or the response from the prospective customer, the virtual agent (112) schedules a meeting with the prospective customer, if the response indicates a positive interest of the prospective customer in the business. In an embodiment, the virtual agent (112) can interact with the prospective customer via the text-based message application (114) to schedule the meeting. In another embodiment, the virtual agent (112) can interact with the prospective customer via the interactive communication platform (116) to schedule the meeting. In order to schedule the meeting, the virtual agent (112) is configured to select a date and time for the meeting based on an availability of the prospective customer. Typically, virtual agent (112) determines the availability from at least one calender application associated with the prospective customer and a work schedule provided by the prospective customer. For example, the work schedule can be a predefined duration each day (e.g. 9 am to 5 pm) when the prospective customer is available for meetings. The calender application can provide time and day slots that are free for the prospective customer. Hence, the virtual agent (112) is configured to refer to both the work schedule and the calender application to determine which day(s) and time(s) the prospective customer is most likely to confirm to the meeting. The virtual agent (112) then suggests the day(s) and time(s) to the prospective customer, and schedules the meeting on a day and time, that is received as a confirmation from the prospective customer. The confirmation can be received via an email, a SMS, or a chat message.

Various applications can be used for arranging the meetings. For example, the virtual agent (112) can be configured to arrange the meeting, on Zoom®, Microsoft Teams®, Go-To-Meeting® and such other applications that host meetings. Depending on which application is chosen, the virtual agent (112) is configured to send a relevant meeting link to the prospective customer.

The virtual agent (112) upon scheduling the meeting is configured to send a reminder to the prospective customer prior to a time of the meeting, to ensure attendance of the prospective customer. During the meeting, the virtual agent (112) engages via the interactive communication platform (116) into an interactive personalized communication, for converting the prospective customer into a customer of the business.

Post completion of the meeting, the virtual agent (112) can update the content database (104) regarding details of the meeting. The virtual agent (112) updates the content database (104) regarding details of the meeting. The details of the meeting are used by the virtual agent (112) in finalizing a deal for purchase with the prospective customer in further communications.

However, incase the prospective customer fails to attend the meeting, the virtual agent (112) is configured to send one or more reminders to re-engage with the prospective customer. Incase the prospective customer fails to respond to the one or more reminders as well, then the virtual agent (112) can remove the prospective customer from the list of prospective customers.

Further, the virtual agent (112) is configured to share details of the prospective customers with one or more customer relationship management (CRM) system. Details from the content database (104) can be shared in parts or in total with a CRM system based on a requirement. Examples of CRM systems that can benefit from the system (100) include CRM systems hosted by Zoho®, HubSpot®, Salesforce® and the like.

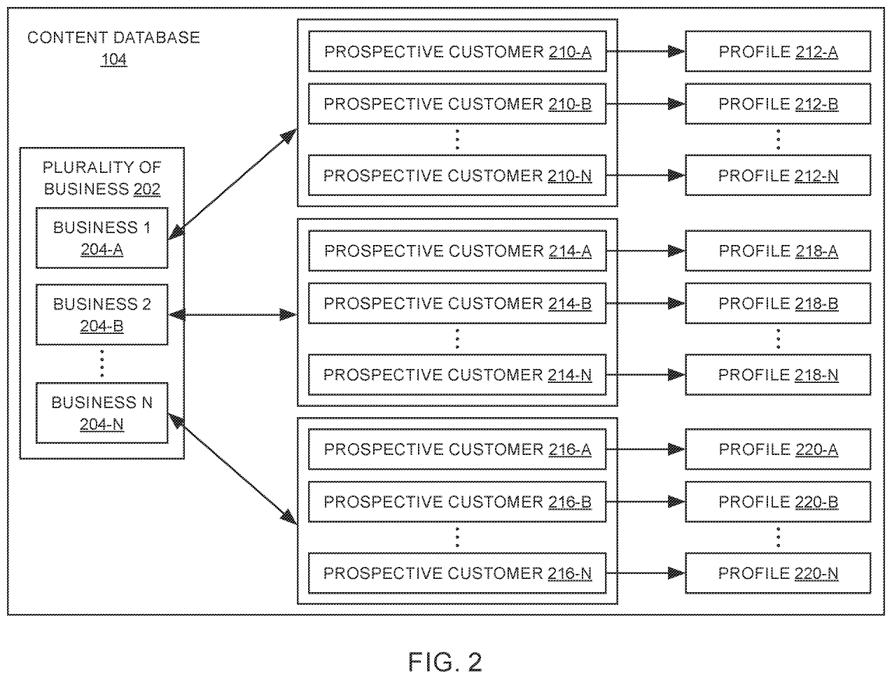

FIG. 2 is a schematic block diagram of the content database (104) of the system (100) of FIG. 1, according to an embodiment of the present invention. As shown, the content database (104) includes details of a plurality of businesses (202). Details of the plurality of business (202) can be stored in separate data blocks (204a-204n). Each business (204a) may have a plurality of prospective customers (210a-210n), as identified by the virtual agent (112). Further, each prospective customer (e.g. 210a) would have a profile. For example, profile of prospective customer (210a) is (212a). For example, the profile (212a) would store the likes, dislikes, personal information, preferences of the prospective customer (210a). Similarly, business (204b) would have a list of prospective customers (214a-214n) and the profiles of the list of prospective customers (214a-214n) are stored as (218a-218n). Further, a list of prospective customers (216a-216n) of business (204n) would have profiles stored as (220a-220n).

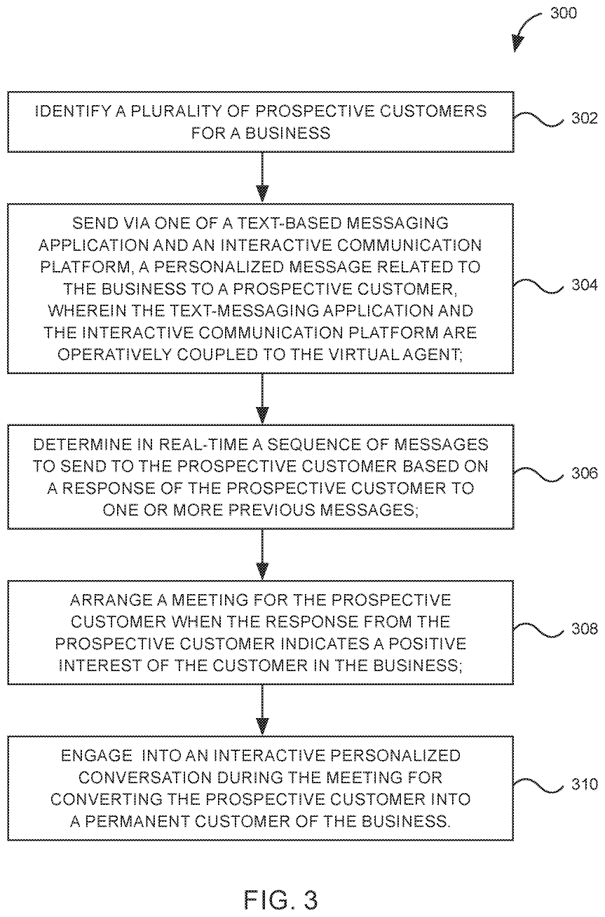

FIG. 3 is a flowchart (300) of a method for implementing a virtual agent for personalized communication, according to some aspects of the present invention.

At 302, a plurality of prospective customers for a business are identified, by a virtual agent implemented by a processing device of an enterprise system. The enterprise system can be implemented on a cloud network, and is communicatively coupled with a plurality of client devices (120a-120n) associated with a plurality of prospective customers for the business. In an embodiment, the virtual agent conducts a market search for identifying the plurality of prospective customers for the business; and creates a content database comprising curated data related to the plurality of businesses, products associated with each business, categories of prospective customers, and a profile of each prospective customer. Typically, the profile includes specific data, preferences and interest of the each prospective customer. In an embodiment, the virtual agent can fetch one or more prospective customers, also known as leads, for a business based on data that an existing customer or an identified prospective customer enters into an interactive communication platform while interacting with the virtual agent.

At 304, a personalized message related to the business is sent via a text-based messaging application or an interactive communication platform or both to the prospective customer. The text-based messaging application and the interactive communication platform are operatively coupled to the virtual agent. For example, the text-based messaging application can be an email application, and a personalized email related to the business and catering to the personal needs of the prospective customer can be sent. Similarly, the interactive communication platform can be a chat application and personalized chat messages can be sent by the virtual agent via the chat application to the prospective customer. In an embodiment, the content database is accessed for retrieving the specific data and interest of the prospective customer; and the personalized message is created based on the specific data and the interest of the prospective customer in relation to the business.

At 306, a sequence of messages to be sent to the prospective customer is determined by the processing device in real-time, where the sequence is determined based on a response of the prospective customer to one or more previous messages. For example, incase, the prospective customer fails to respond to a first email, then a reminder email is sent post a predefined time period (e.g. three days) to the prospective customer. On the other hand, if the prospective customer responds negatively to the first email, then the sequence to messages to be sent to such prospective customer is terminated. However, if the prospective customer responds positively by asking for further information on the business, then a second email can be further personalized to answer the query of the prospective customer, and providing the information that would motivate the prospective customer to enroll for the service or buy the products offered by the business.

At 308, a meeting with the prospective customer is arranged by the virtual agent, when the response from the prospective customer indicates a positive interest of the prospective customer in the business.

At 310, the prospective customer is engaged into an interactive personalized conversation by the virtual agent via the interactive communication platform, during the meeting for converting the prospective customer into a permanent customer of the business.

In an embodiment, a plurality of information about the prospective customer is retrieved from one or more conversational inputs provided by the prospective customer during the interactive communication, and a personalized video is generated based on the profile of the prospective customer, and the plurality of information retrieved from the one or more conversational inputs. Further, the personalized video is transmitted via the interactive communication platform, for promoting sale of one or more products or services related to the business to the prospective customer.

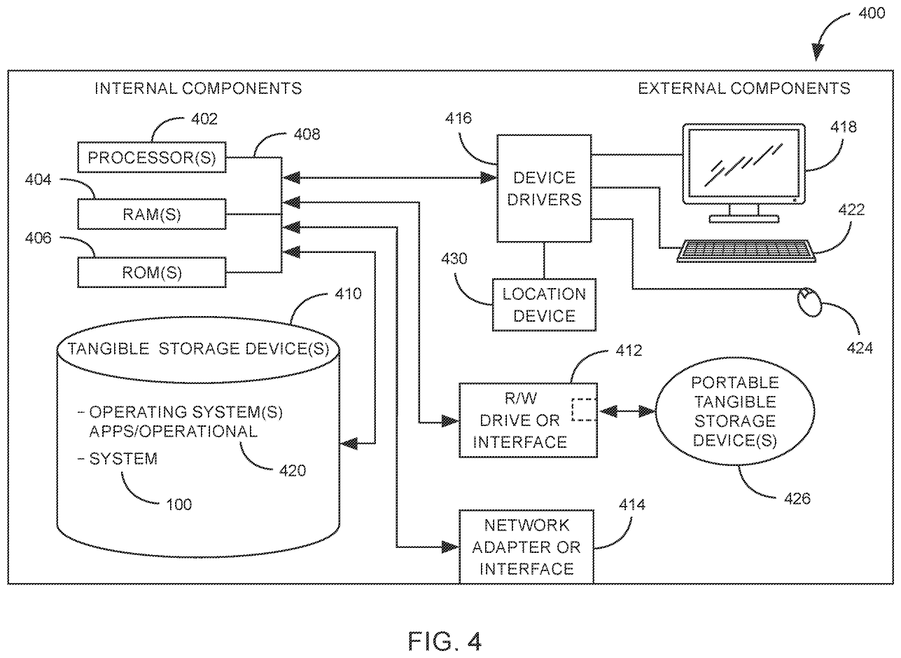

The modules of the system (100) for implementing a virtual agent for personalized communication, described herein are implemented in computing devices. One example of a computing device (400) is described below in FIG. 4. The computing device (400) includes one or more processor(s) (402), one or more computer-readable RAMs (404) and one or more computer-readable ROMs (406) on one or more buses (408). Further, computing device (400) includes a tangible storage device (410) that may be used to execute operating systems (420) and the system (100). The various modules of the system (100) may be stored in the tangible storage device (410). Both, the operating systems (420) and the system (100) are executed by the one or more processor(s) (402) via one or more respective RAMs (404) (which typically include cache memory). The execution of the operating systems (420) and/or the online platform system (100) by the one or more processor(s) (402), configures the one or more processor(s) (402) as a special purpose processor configured to carry out the functionalities of the operation systems (420) and/or the system (100) as described above.

Examples of the tangible storage device (410) include semiconductor storage devices such as ROM, EPROM, flash memory or any other computer-readable tangible storage device that may store a computer program and digital information.

Computing device (400) also includes a R/W drive or interface (414) to read from and write to one or more portable computer-readable tangible storage devices (428) such as a CD-ROM, DVD, memory stick or semiconductor storage device. Further, network adapters or interfaces (412) such as a TCP/IP adapter cards, wireless Wi-Fi interface cards, or 3G or 4G wireless interface cards or other wired or wireless communication links are also included in computing device.

In one example embodiment, the system (100) may be stored in the tangible storage device (410) and may be downloaded from an external computer via a network (for example, the Internet, a local area network or other, wide area network) and network adapter or interface (412).

Computing device (400) further includes device drivers (416) to interface with input and output devices. The input and output devices may include a computer display monitor (418), a keyboard (422), a keypad, a touch screen, a computer mouse (424), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A system comprising:
a memory comprising instructions; and
a processing device operatively coupled to the memory, the processing device to execute the instructions to facilitate a virtual agent to:
identify a plurality of prospective customers for a business;
send via a text-based messaging application operatively coupled to the virtual agent a personalized message related to the business to a prospective customer;
determine in real-time a sequence of messages to send to the prospective customer based on a response of the prospective customer to one or more previous messages;
arrange a meeting for the prospective customer when the response from the prospective customer indicates a positive interest of the prospective customer in the business; and
engage via an interactive communication platform into an interactive personalized communication during the meeting for converting the prospective customer into customer of the business.

2. The system of claim 1, wherein the virtual agent to:
conduct a market search for identifying a plurality of prospective customers for a plurality of businesses; and
create a content database comprising curated data related to the plurality of businesses, products associated with each business, a set of prospective customers for each business, and a profile of each prospective customer, wherein the profile includes specific data, preferences and interest of each prospective customer.

3. The system of claim 2, wherein the virtual agent to:
access the content database for retrieving the specific data and interest of the prospective customer; and
create the personalized message based on the specific data and the interest of the prospective customer in relation to the business.

4. The system of claim 2, wherein to engage into the interactive personalized communication the virtual agent to:
retrieve a plurality of information about the prospective customer from one or more conversational inputs provided by the prospective customer during the interactive communication;
generate a personalized video based on the profile of the prospective customer, and the plurality of information retrieved from the one or more conversational inputs; and
transmit via the interactive communication platform, the personalized video for promoting sales of one or more products or services related to the business to the prospective customer.

5. The system of claim 1, wherein the virtual agent to:
send a first message to the prospective customer based on a profile and preferences of the prospective customer, wherein the profile and the preferences are stored in a content database;
send a reminder message to the prospective customer when the prospective customer fails to open the message or reply to the message within a first predefined time period;
remove the prospective customer from a list of prospective customers stored in the content database when the prospective customer fails to reply to the reminder message within a second predefined time period; and
schedule the meeting with the prospective customer when a reply to at least one of the reminder message and the first message received indicates a positive interest of the prospective customer in the business.

6. The system of claim 5, wherein the virtual agent upon scheduling the meeting is configured to:
send a reminder to the prospective customer prior to the time of the meeting; and
update the database regarding details of the meeting, wherein an attendance of the prospective customer in the meeting is updated.

7. The system of claim 6, wherein the virtual agent is further configured to:
send one or more reminders to re-engage with the prospective customer when the prospective customer fails to attend the meeting; and
remove prospective customer from the list of prospective customers, when the prospective customer fails to respond to the one or more reminders.

8. The system of claim 1, wherein to arrange the meeting, the virtual agent is further configured to:
select a date and time for the meeting based on an availability of the prospective customer, wherein the availability is determined from at least one calender application associated with the prospective customer and a work schedule provided by the prospective customer.

9. The system of claim 1, wherein the virtual agent is further configured to:
share details of the prospective customers with one or more customer relationship management system.

10. The system of claim 1, wherein the text-based messaging application is selected from a group consisting of Short Message Service (SMS), Instant Messaging (IM), and email.

11. A method comprising:
identifying, by a virtual agent implemented by a processing device, a plurality of prospective customers for a business;
sending, via one of a text-based messaging application and an interactive communication platform, a personalized message related to the business to a prospective customer, wherein the text-messaging application and the interactive communication platform is operatively coupled to the virtual agent;
determining, by the virtual agent, in real-time a sequence of messages to send to the prospective customer based on a response of the prospective customer to one or more previous messages;
arranging, by the virtual agent, a meeting for the prospective customer when the response from the prospective customer indicates a positive interest of the customer in the business; and
engaging, by the virtual agent, via the interactive communication platform into an interactive personalized conversation during the meeting for converting the prospective customer into a permanent customer of the business.

12. The method of claim 11, further comprising:
conducting a market search for identifying a plurality of prospective customers for the business; and
creating a content database comprising curated data related to the plurality of businesses, products associated with each business, categories of prospective customers, and a profile of each prospective customer, wherein the profile includes specific data, preferences and interest of the each prospective customer.

13. The method of claim 12, further comprising:
accessing the content database for retrieving the specific data and interest of the prospective customer; and
creating the personalized message based on the specific data and the interest of the prospective customer in relation to the business.

14. The method of claim 12, wherein engaging into the interactive personalized communication further comprises:
retrieving a plurality of information about the prospective customer from one or more conversational inputs provided by the prospective customer during the interactive communication;
generating a personalized video based on the profile of the prospective customer, and the plurality of information retrieved from the one or more conversational inputs; and
transmitting via the interactive communication platform, the personalized video for promoting sale of one or more products or services related to the business to the prospective customer.

15. The method of claim 11, further comprising:
sending a first message to the prospective customer based on a user profile and user preferences, wherein the user profile and user preferences is stored in a content database;
sending a reminder message to the prospective customer when the prospective customer fails to open the message or reply to the message within a first predefined time period;
removing the prospective customer from a list of prospective customers stored in the content database when the prospective customer fails to reply to the reminder message within a second predefined time period; and
scheduling the meeting with the prospective customer when a reply to at least one of the reminder message and the first message received indicates a positive interest of the prospective customer in the business.

16. The method of claim 15, scheduling the meeting further comprises:
sending a reminder to the prospective customer prior to the time of the meeting; and
updating the database regarding details of the meeting.

17. The method of claim 16, further comprising:
sending one or more reminders to re-engage with the customer when the prospective customer fails to attend the meeting; and
removing prospective customer from the database when the prospective customer fails to respond to the one or more reminders.

18. The method of claim 11, wherein the text-based messaging application is selected from a group consisting of Short Message Service (SMS), Instant Messaging (IM), and email.
